(19) United States
(12) Patent Application Publication
(10) Pub. No.: US 2025/0136355 A1
(43) Pub. Date: May 1, 2025

(54) CAPSULE TO EXTRACT ESSENCE OF HYDROSCOPIC SUBSTANCES CONTAINED WITHIN

(71) Applicant: Davoud Falati, Vancouver (CA)

(72) Inventor: Davoud Falati, Vancouver (CA)

(21) Appl. No.: 18/384,440

(22) Filed: Oct. 27, 2023

(51) Int. Cl. B65D 85/804; A23F 3/18

(52) U.S. Cl. CPC B65D 85/8055; A23F 3/18

(57) ABSTRACT

A capsule is disclosed that comprises a sealed body that encloses one or more cavities containing one or more substances including at least one hygroscopic substance and one or more objects within. Pressurized liquid is introduced into a cavity using a suitable device from one or more areas of the capsule body, to interact with the substance(s) within. The object(s) are configured to alter the characteristics of the flow of the liquid, particularly in contact with the hygroscopic substance(s). The liquid exits from one or more areas of the capsule body, having optimally extracted the essence of the substance(s) due to the altered flow rate, liquid exposure, flow distribution, and flow patterns.

### BACKGROUND OF THE INVENTION

The preparation of beverages using a capsule containing beverage ingredients in known. In general, this process involves a—sometimes sealed—capsule containing ingredient(s)—such as ground roasted coffee—inserted into a beverage production device—such as a Nespresso or a Keurig machine—then liquid—such as water—passed through the capsule by the device, either with or without applied pressure. The liquid interacts with the beverage ingredients the essence is extracted, resulting in a beverage.

Various constructions for beverage capsules are known. Some constructions employ a capsule with some porous exterior surface(s) where the liquid in introduced and/or exits the capsule. Some constructions are completely nonporous such that the capsule can be pressurized with the liquid, to assist in the extraction of essence into the liquid. Capsule constructions that are permeable or porous, naturally expose the contained ingredients to some elements, particularly air, humidity, or light, which may expedite some alteration in the ingredients, causing spoilage, staleness, diminished freshness, or lose potency.

In cases where a hygroscopic substance—such as tea leaves—is an ingredient inside a beverage capsule, pressurized liquid methods using nonporous capsules have not been used. The physical and chemical properties of hygroscopic ingredients in an enclosed capsule under liquid pressure impede desirable extraction. For example, in constructions where a tea beverage is to be prepared from a sealed, nonporous capsule, actual tea leaves have not been used; instead, already extracted tea granules or water-soluble tea substitutes are typically used as the ingredient. As a result, the produced tea beverage is not equivalent to extracting the tea beverage from actual tea leaves, and is more akin to an instant tea beverage. Further, it has different taste, aroma, and potency than a tea beverage derived from actual tea leaves would have.

Therefore, there is a need for a sealed, nonporous capsule construction that enables preparation of a desirable beverage—such as tea-using hygroscopic substances—such as tea leaves—in a beverage preparation machine that utilizes liquid pressure—such as a Nespresso Original Line machine.

### SUMMARY OF THE INVENTION

The present invention relates to a sealed, nonporous capsule to facilitate extraction of essence from hygroscopic ingredient(s) inside, by introducing pressurized liquid into the capsule and retrieving the liquid after its interaction with those ingredients. As one example, such construction can be employed to implement a sealed beverage capsule containing tea leaves, in a beverage preparation machine that uses water pressure to prepare a tea beverage.

An enclosed nonporous capsule is comprised of one or more nonporous material(s)—such as metals, metal alloys or plastics—in any shape and/or dimensions, defining boundaries of its body and forming one or more internal cavities where one or more substances and object(s) may be placed prior to being sealed-in using a sealing cap, lid or another form of construction. When the capsule is inserted into a suitable extraction device, one or more surfaces of the capsule is pierced, punctured or otherwise penetrated and pressurized liquid is introduced into the cavity. An exit for the liquid is also introduced in one or more surfaces of the capsule by the extraction machine. The object(s) sealed-in, modify the route, manner, pace, and distribution of the liquid within the cavity of the capsule. Liquid is then pressurized and dispensed into the cavity to interact with the substance(s) and object(s) and exit the capsule, in order to extract the essence of the substance(s).

One aspect of the present disclosure is directed to an enclosed capsule, comprising a capsule body, constructed of non-porous material(s), wherein one or more surface areas of the capsule body are configured to allow piercing to enable entry of a liquid, and one or more surface areas of the capsule body are configured to allow for piercing to enable exit of a liquid; and one or more substances comprising at least one hygroscopic substance, disposed within the capsule body prior to the capsule being sealed; and one or more objects disposed within the capsule body prior to the capsule being sealed, wherein the object(s) are configured to modify the flow characteristics of a pressurized liquid through the capsule body. In one embodiment, a capsule comprises a multiple of boundaries forming an internal cavity.

The object(s) are constructed from various materials and configured to modify the exposure of substance(s) to the liquid, flow distribution and/or flow rate and/or flow patterns of the liquid inside the capsule cavity, and/or to offer some resistance against the flow. The object(s) are configured to modify the exposure of substances as described above and these modifications facilitate a more optimized extraction of essence from the hygroscopic substance(s) inside the capsule. Various embodiments of one or more various objects and configurations are utilized.

In one embodiment, one or more objects are configured between the substance(s) and one or more cavity boundaries. In one embodiment, one or more objects are configured between layers of substance(s). In one embodiment, the object(s) are mixed with the substance(s). In one embodiment, some object(s) are mixed with the substances, while other object(s) are configured in between layers of substances.

In one embodiment, the object(s) are detached from the capsule body. In one embodiment, the object(s) are attached to the capsule body. In one embodiment, some object(s) are attached to the capsule body, while other object(s) are detached to the capsule body.

In one embodiment, the object(s) are porous, permeable or perforated or have open channels within. In one embodiment, the object(s) are contiguous and of stern construction. In one embodiment, some object(s) are of porous, permeable or perforated or channeled, while object(s) are contiguous and stern in construction.

In one embodiment, the object(s) feature texture(s), channel(s), recession(s) or ridge(s) on their surface(s). In one embodiment, the object(s) are smooth on their surfaces. In one embodiment, some object(s) feature texture(s), channel(s), recession(s) or ridge(s) on their surface(s) while other objects are smooth on their surfaces.

In one embodiment, the object(s) have planar surfaces. In one embodiment, the object(s) have curved surfaces. In one embodiment, the object(s) are flat and relatively smaller in one dimension, resembling a surface. In one embodiment, the object(s) are polytopal or spherical. In one embodiment, some or all surfaces of the object(s) are convex. In one embodiment, some or all surfaces of the object(s) are concave. In one embodiment, some object(s) have planar surfaces while others have curved surfaces. In one embodiment, some object(s) are flat and relatively smaller in one dimension, resembling a surface while some other object(s) are polytopal or spherical. In one embodiment, some or all surfaces of some object(s) are convex while some object(s) have surfaces that are concave.

In one embodiment, the object(s) fit snugly inside the cavity. In one embodiment, the object(s) are free to relocate within the cavity. In yet another embodiment, the object(s) comprise different characteristics including shapes, dimensions, placements, arrangements, perforations, ridges, textures and channels and arrangement of these characteristics.

In one aspect, the present invention relates to a capsule used in the beverage dispensing industry. In this one example, the capsule comprises a capsule body and one or more objects. The capsule body, in one example, comprises a base, an injection wall, a plurality of sidewalls, and one or more portions. In one embodiment, the sidewalls extend between the base and the injection wall to form the hermetically sealed compartment. In one embodiment, the compartment comprises at least one layer of hygroscopic substance. In another embodiment, the objects are one or more membranes disposed within the compartment.

One embodiment of the capsule comprises a capsule body that comprises an injection wall that is configured to be pierced by a beverage preparation device to form an opening on the injection wall. In one embodiment, the injection wall is a penetrating surface. In this example, the opening on the penetrating surface allows for a liquid to flow between the opening and the compartment. The liquid path enables the passage of a pressurized liquid, for example, pressurized water dispensed from the beverage preparation device. In one embodiment, the liquid flows through the object and the hygroscopic substance in the compartment and exits through the base of the capsule (exit surface). In an embodiment, the base comprises one or more perforations to enable the liquid to exit from the capsule. In one embodiment, the base further comprises a lid. In one embodiment, the lid is detachably affixed to the base and configured to close the openings at the base.

In one embodiment, the object is configured to modify the flow rate and flow distribution of the liquid to offer resistance to the flow of the liquid and distributes the liquid more evenly across the hygroscopic substance. The even distribution of liquid, in one example, enables optimal extraction of essence from the hygroscopic substance as the liquid exits through the base. In one embodiment, the objects are disposed adjacent to the injection wall and the hygroscopic substances are disposed between the objects and the base. In another embodiment, the objects are disposed adjacent to the base and the hygroscopic substances are disposed between the objects and the injection wall. In another embodiment, the compartment comprises one or more layers of hygroscopic substance and the objects are disposed between the layers of the hygroscopic substance.

In one embodiment, the objects are disposed at least one of above and below the hygroscopic substance. In one embodiment, the object(s) are disposed between two or more layers of the hygroscopic substance. In one embodiment, the object(s) are mixed with the hygroscopic substance(s). In one embodiment, at least one object is disposed a) between substance(s) and one or more cavity boundaries, or b) between layers of substance(s), or c) in a mix with the substance(s).

In one embodiment, the objects comprise at least one of a textured surface and a smooth surface. In another embodiment, at least one object comprises at least one textured surface, smooth surface, recession on a surface, channel on a surface, or ridge on a surface. The objects comprise, in one embodiment, one or more perforations. At least one object comprises one or more perforations. In one embodiment, the object comprises one or more internal open channels. In another embodiment, the object comprises one or more channels defined at an exterior surface of the object. The object, in one embodiment, has a solid structure with no holes. In yet another embodiment, the object comprises one or more ridges defined at the exterior surface of the object. In yet another embodiment, the plurality of objects comprises different characteristics including shape, dimension, arrangement of perforations, arrangement of ridges and arrangement of perforations.

In one embodiment, at least one object is attached to one or more of cavity surfaces. In another embodiment, at least one object is detached from all cavity surfaces. In one embodiment, at least one object fits snugly inside the cavity such that it may not relocate. In another embodiment of the capsule, at least one object comprises at least one curved surface, or at least one object comprises at least one planar surface, or at least one object resembles a surface due to its dimensions, or at least one object is spherical in geometry, or at least one object is polytopal in geometry, or at least one object comprises at least one convex surface, or at least one object comprises at least one concave surface.

In one embodiment, the objects are one or more membranes within the compartment that allow for liquid to traverse across them. In one embodiment, the compartment has a c-shaped cross-section and the membrane has a c-shaped profile complementary to the cross-section of the compartment to enable the membrane to snugly fit within the compartment. In one embodiment, the membrane comprises one or more perforations. In one embodiment, the perforations are evenly distributed across a surface of the membrane. The perforations may be symmetrically distributed across the surface of the membrane.

In one embodiment, the membrane comprises at least one of a textured surface and a smooth surface. In one embodiment, the membrane comprises one or more legs extending from the surface of the membrane towards the substance in the compartment. In one embodiment, the membrane is disposed at least one of above and below the substance. In another embodiment, the membranes are disposed between two or more layers of the substance.

One aspect of the present disclosure is directed to a beverage capsule. In this particular example, the beverage capsule comprises (a) a capsule body comprising a base, an injection wall and a plurality of sidewalls extending between the base and injection wall to define a hermetically sealed compartment, wherein the base comprises one or more openings and a lid detachably affixed to the base to close the openings, wherein the compartment comprises at least a layer of hygroscopic substance, wherein the injection wall is configured to be pierced to allow flow of liquid from a beverage preparation device to flow through the hygroscopic substance and the base is configured to dispense the liquid flowing through the hygroscopic substance; and (b) one or more objects disposed within the compartment, wherein the object is configured to modify the flow rate and flow distribution of the liquid so as to offer resistance to the flow of the liquid and distribute the liquid evenly across the hygroscopic substance to enable optimal extraction of essence from the hygroscopic substance as the liquid exits through the base.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

FIG. 1A-1F exemplarily illustrates a perspective view of different types of beverage capsules, according to an embodiment of the present invention;

FIG. 2A-2J exemplarily illustrates a top view of different types of membranes, according to an embodiment of the present invention;

FIG. 3A-3H exemplarily illustrates a cross-sectional view of different types of membranes, according to another embodiment of the present invention;

FIG. 4A-4F exemplarily illustrates a cross-sectional view of different types of membranes having different types of ridges, according to an embodiment of the present invention;

FIG. 5A-5J exemplarily illustrates a cross-sectional view of membranes having one or more legs, according to an embodiment of the present invention; and

FIG. 6A-6T exemplarily illustrates a top view of the membrane having different patterns of perforations, according to an embodiment of the present invention.

### DETAILED DESCRIPTION

The present disclosure discloses a capsule configured to provide improved extraction of essence of substance(s) inside, using pressurized liquid.

A description of embodiments of the present disclosure will now be given with reference to the figures. It is expected that the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

Before any embodiments of the invention are explained in detail, it is to be understood that the disclosure is not limited in its application to the details of construction nor to the arrangement of components set forth in the following description or illustrated in the drawings. The disclosure is capable of other embodiments and of being practiced or of being carried out in various ways.

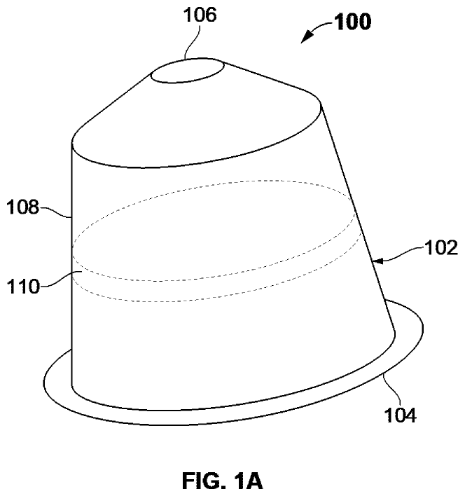

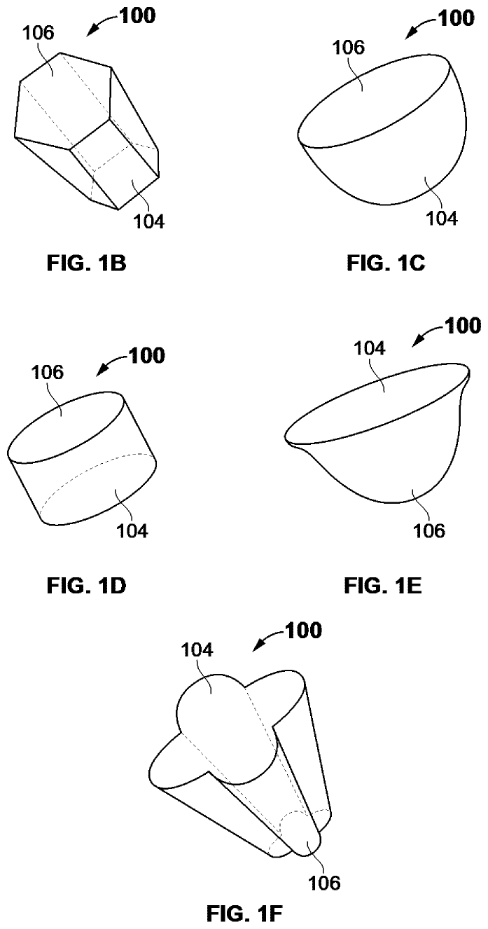

FIG. 1A-1F exemplarily illustrate a perspective view of different types of beverage capsules 100, according to an embodiment of the present invention. In one embodiment, the capsule 100 comprises a capsule body 102 and one or more objects. In another embodiment, the capsule body 102 comprises a base 104 (exit surface), an injection wall (penetration surface) 106 and a plurality of sidewalls (other surfaces) 108 surfaces together comprise a sealed cavity that is a hermetically sealed compartment; that is, the sidewalls 108 extends between the base 104 and the injection wall or penetration surface 106 to define the hermetically sealed compartment. The compartment comprises, in one embodiment, at least a layer of one substance, which can be hygroscopic in characteristic. One or more object(s), in one embodiment, are disposed within the compartment and the compartment is then sealed.

In one embodiment, the injection wall or penetration surface 106 is configured to be pierced by a beverage preparation device to form an opening on the injection wall 106 and into the compartment. The opening allows for a liquid path between the opening and the compartment, enabling the passage of a pressurized liquid, for example, pressurized water dispensed from the beverage preparation device. In such an example, the liquid flows through the object(s) and the substance(s) in the compartment. In one embodiment, the exit surface 104 is configured to be pierced by a beverage preparation device to form an exit route for the liquid flowing through the compartment. In one embodiment, the exit surface 104 is pierced with one or more holes to enable the liquid to exit from the capsule 100. In one embodiment, the exit surface 104 is also the capsule's lid. In one embodiment, the lid is affixed to the capsule at time of construction to create the seal, after the objects(s) and substance(s) are placed inside the compartment. In another embodiment, the exit surface and the lid are distinct surfaces. In one embodiment, the lid is detachably affixed to the exit surface 104 and is configured to close the openings defined at the exit surface 104.

Referring to FIGS. 1A, 1C, 1D and 1E, the beverage capsules 100 has a circular cross-section. Referring to FIGS. 1A, 1C, and 1E the beverage capsules 100 substantially resemble a cup shape. Referring to FIG. 1B, the beverage capsule 100 has a hexagonal cross-section. The beverage capsule 100, in one example, has a hexagon shape. Referring to FIG. 1D, the beverage capsule 100 has a cylindrical shape. Referring to FIG. 1F, the beverage capsule 100 has an irregular shape and an irregular cross-section.

In one embodiment, the object(s) are configured to modify the flow rate and flow distribution of the liquid so as to offer resistance to the flow of the liquid and distributes the liquid more evenly across the substance(s). The even distribution of liquid enables optimal extraction of essence from substance(s) as the liquid exits through the exit surface or base 104. In an embodiment, the object(s) are disposed at a portion 110 within the compartment. In one embodiment, the object(s) are disposed adjacent to the penetration surface (injection wall) 106 and the substance(s), which can be hygroscopic, are disposed between the object(s) and the exit surface 104. In another embodiment, the object(s) are disposed adjacent to the exit surface 104 and the hygroscopic substance(s) are disposed between the objects and the penetration surface (injection wall) 106.

In one embodiment, the compartment comprises one or more layers of hygroscopic substance(s) and the object(s) are disposed between the layers of the hygroscopic substance. In one embodiment, the object(s) are free to move around within the compartment. In one embodiment, the object(s) are affixed or snugly fit, inside the compartment. In one embodiment, the substance(s) are free to intermingle with the object(s). In one embodiment, the object(s) limit the movement of the substance(s) inside the compartment. In one embodiment, the substance(s) and object(s) are layered inside the compartment.

In one embodiment, the objects include, but are not limited to, balls, cubes, discs and hollow spheres and other shapes of various sizes, masses, shapes, surface textures, and materials. In one embodiment, the objects are mixed with the substance(s) in the compartment. The substance may be a hydrophilic/hygroscopic substance. The substance(s) for the preparation of a beverage are selected from a group including but not limited to: powders, soluble powders, granules, flakes, pieces of various single or compound bases, such as: tea leaves, ground roasted coffee, instant coffee, dry flavouring extracts, sugars, instant tea, cocoa-based powders, and other dehydrated edible substance(s), or a mix thereof.

In one embodiment, the object(s) comprise at least one of a textured surface or smooth surface. The surface may include one or more perforations. In one embodiment, the object(s) include channels. The channels improve the flow of liquid and prevent blockage of the flow of liquid by a hygroscopic substance.

According to the present invention, the object(s) available in adequate number, mass, and size offer some resistance to the flow of liquid. Further, the object(s) prevent blockage of the passage of the liquid, to exit the compartment.

In one embodiment, the plurality of object(s) has different shapes and different textures on the external surface of the object(s) to create an irregularity with respect to the shapes and the surface of different object(s). The irregularity prevents the object(s) from snugly fitting to adjacent object(s) and/or the substance(s). As a result, the object(s) with irregularity provide improved performance by uniform distribution of flow of liquid and prevent blockage of flow of liquid by the combination of substance(s) and the object(s).

In one embodiment, the object is a membrane 112. The membrane 112 is disposed within the capsule body 102 and transverse to the flow of the liquid. In one embodiment, the membrane 112 has its peripheral edges matching the shape 108 of the capsule body 102 to prevent dislocation of the membrane 112 inside the compartment. In one embodiment, membrane 112 has a cup-shaped structure with the edges mimicking the sidewalls 108 of the capsule body 102 to prevent any rotary dislocation of the membrane 112 inside the compartment. In one embodiment, the compartment has a c-shaped cross-section and the membrane 112 has a c-shaped profile complementary to the cross-section of the compartment to enable the membrane 112 to snugly fit within the compartment.

The membrane 112 is placed inside the capsule body 102. The membrane 112 extends across the compartment to cover a surface area of the hygroscopic substance and engages the surface 108 of the capsule body 102. The membrane 112 has a significant thickness and material strength to withstand the force during the introduction of liquid into the compartment. In one embodiment, the membrane 112 is moderately perforated to improve the even distribution of liquid into the substance beyond the membrane 112. In one embodiment, the membrane 112 is disposed adjacent to the penetration surface 106 and the hygroscopic substance(s) are disposed between the membrane 112 and the base 104. In another embodiment, the membrane 112 is disposed adjacent to the exit surface 104 and the hygroscopic substances are disposed between the membrane 112 and the entry surface 106. In another embodiment, the compartment comprises one or more layers of hygroscopic substance(s) and the membrane 112 is disposed between the layers of the hygroscopic substance(s).

In one embodiment, the membrane 112 is disposed at least one of above and below the hygroscopic substance(s). In one embodiment, the membrane 112 is disposed between two or more layers of the hygroscopic substance(s). In one embodiment, the membrane 112 comprises at least one of a textured surface and a smooth surface. When liquid is introduced into the base 104 of the capsule body 102, the loose membrane 112 modifies the flow of the liquid inside the compartment, by producing some resistance and a movement guide.

Additionally, membrane 112 changes the rate of flow of liquid and exposure of the hygroscopic substance(s) to the flow of liquid and allows the liquid to extract the essence of the hygroscopic substance and successfully exit the capsule body 102. In one embodiment, the membrane 112 of various quantities, shapes, sizes, masses, and materials is positioned inside the capsule body 102. The membrane 112 is made of materials selected from a group including, but not limited to, metal or alloys, paper, organic fibrous masses, plastics, glass; or meshes or perforated sheets or other variations of such material.

According to the present disclosure, the object(s) are placed in relation to the hygroscopic substance(s). The placement of the object(s) with respect to hygroscopic substance(s) plays an important role. In one embodiment, due to the loose nature of the object(s) and the hygroscopic substance(s) inside the compartment, the position and layout of the objects may change variably and unpredictably, subject to nature of the movement, mass and shape of the object(s) in relation to the hygroscopic substance(s), the shape of the compartment, and level of object(s) and hygroscopic substance filled in the compartment. Thus, the object(s) distributed within layers of the hygroscopic substance(s), including among, under, and above the hygroscopic substance, exhibit improved performance.

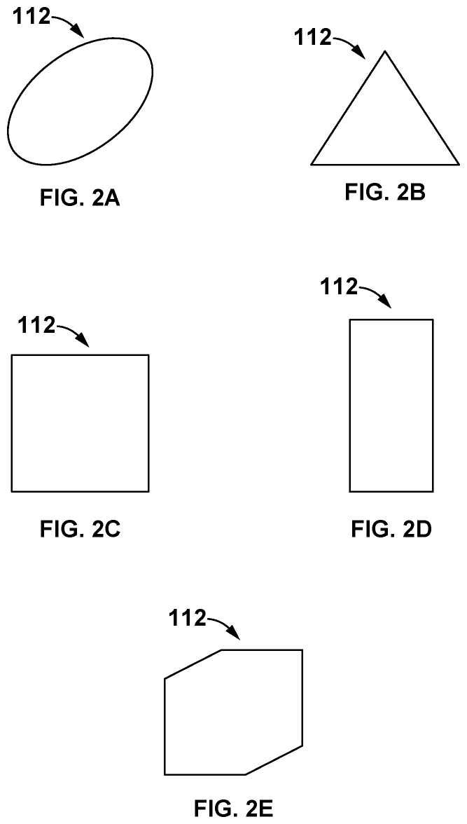

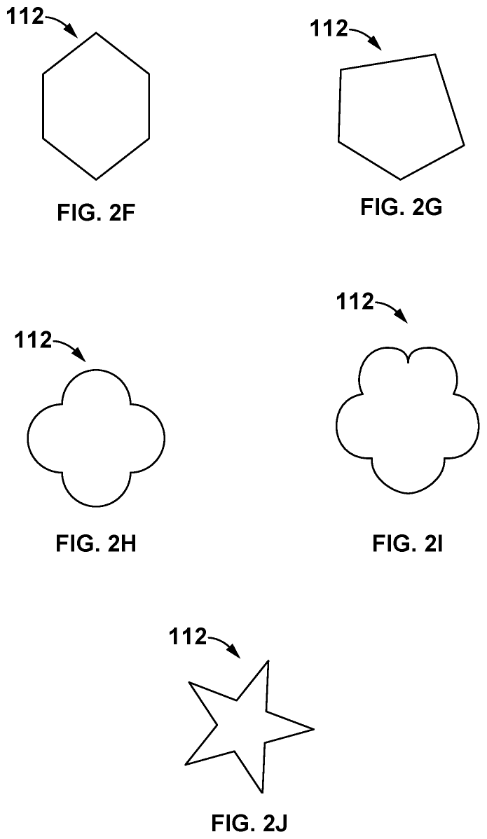

Referring to FIG. 2A-FIG. 2J, a top view of different types of membranes 112, according to an embodiment is disclosed. In one embodiment, the membrane 112 is designed in various shapes, sizes, masses, and materials. The membrane 112 is made of at least one material selected from a group including, but not limited to, metal or alloys, paper, organic fibrous masses, plastics, glass, meshes of metal, perforated sheets of metal and/or papers. In one embodiment, the membrane 112 with a mass and size that offers adequate resistance against the level of pressure exerted by the liquid in the compartment exhibits improved performance.

The optimal shape, size, and fit of the membrane 112 may vary depending on the shape and size of the compartment, and the types and proportions of substance(s) in the compartment. In one embodiment, the compartment comprises one or more membranes 112 of different shapes. In one embodiment, the membrane 112 has an oval shape as shown in FIG. 2A. In another embodiment, the membrane 112 has a triangular shape as shown in FIG. 2B. In yet another embodiment, the membrane 112 has a square shape as shown in FIG. 2C. In yet another embodiment, the membrane 112 has a rectangular shape as shown in FIG. 2D. In yet another embodiment, the membrane 112 has regular and irregular polygonal shapes as shown FIG. 2E to FIG. 2G. FIG. 2H-FIG. 2I illustrate different irregular shapes of membranes 112. In yet another embodiment, the membrane 112 has a star shape as shown in FIG. 2J.

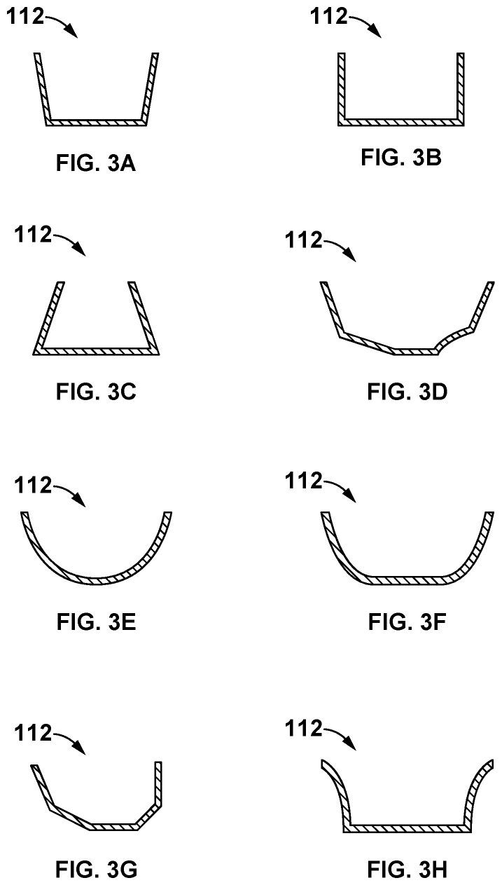

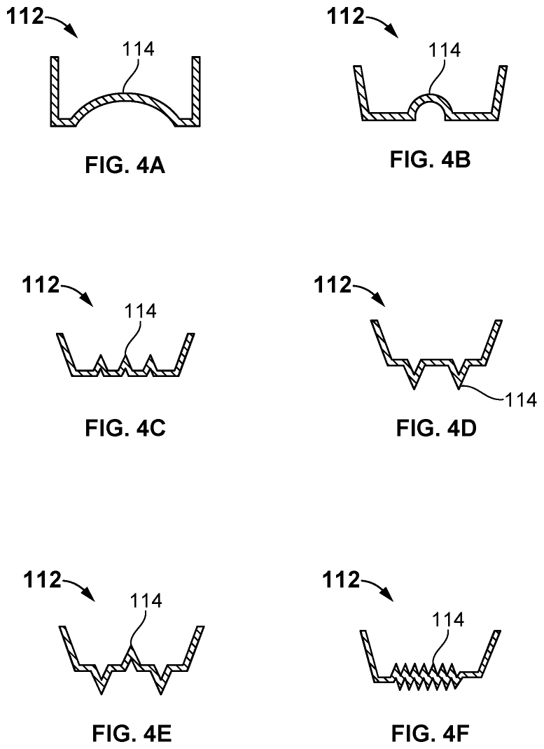

Referring to FIG. 3A-FIG. 3H, a cross-sectional view of different types of membranes 112, according to another embodiment is disclosed. Referring to FIG. 4A-4F, a cross-sectional view of different types of membranes 112 having one or more ridges 114, according to one embodiment is disclosed. Referring to FIG. 4A and FIG. 4B, the ridges 114 are a raised arcuate surface. Referring to FIG. 4C to FIG. 4F, the ridges 114 are a triangular protrusion.

In one embodiment, the membrane 112 comprises at least one ridge 114 that extends upwards with respect to the entry/penetrating surface 106 as shown in FIG. 4A-FIG. 4C. In one embodiment, the membrane 112 comprises one or more ridges 114 that extend downwards with respect to the penetrating surface 106 as shown in FIG. 4D. In one embodiment, the membrane 112 comprises one or more ridges 114 that extend upwards and downwards alternatively, with respect to the penetrating surface 106, as shown in FIG. 4E and FIG. 4F.

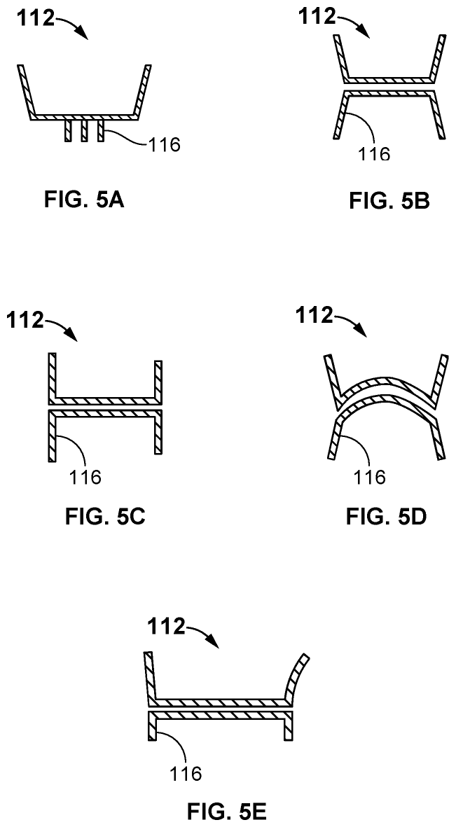

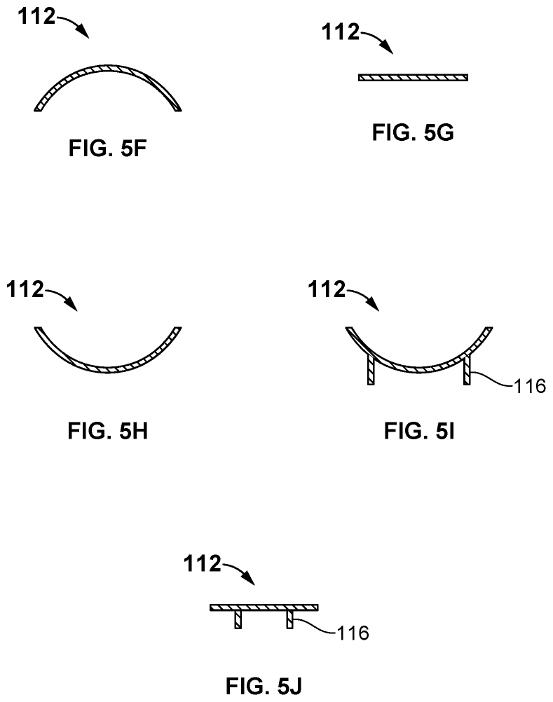

Referring to FIG. 5A-FIG. 5J, a cross-sectional view of the membrane 112 having one or more extruding legs 116, according to an embodiment is disclosed. The legs 116 are spaced apart from each other. In one embodiment, the legs 116 extend downwards from the middle or edges of the membrane 112 with respect to the penetrating surface 106. In another embodiment, the legs 116 extend from the membrane 112 at an angle with respect to the membrane 112. The angle of position of the extruding legs 116, in one embodiment, limits the movement of the membrane 112 inside the compartment due to liquid pressure. In one embodiment, the membrane 112 with extruding legs 116 limits the movement of the membrane 112 and provides resistance to the movement of the membrane 112. Further, for example, the membranes 112 of same or different shapes could be placed back-to-back.

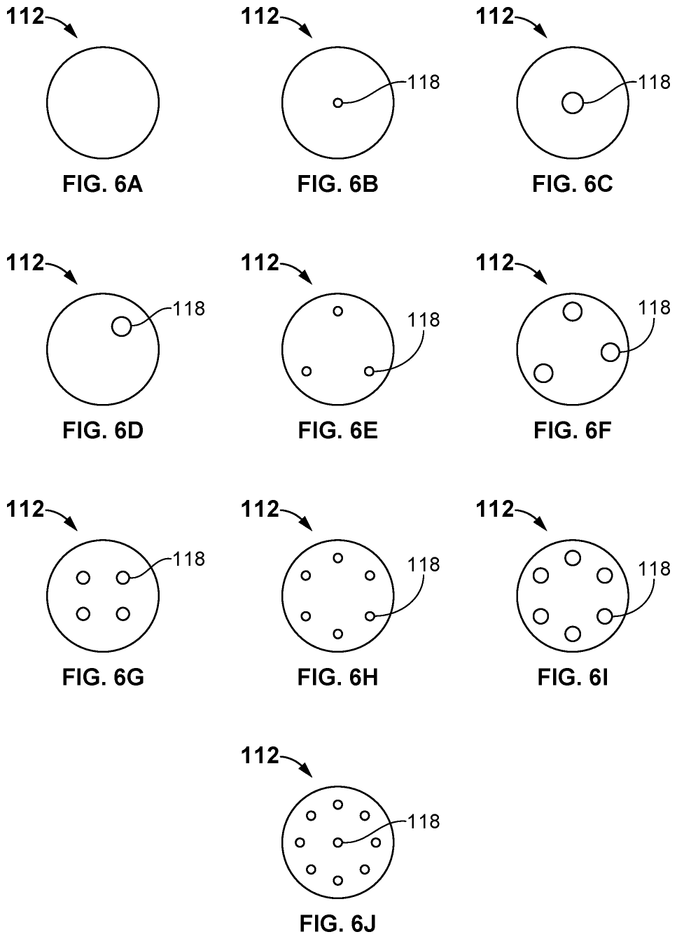

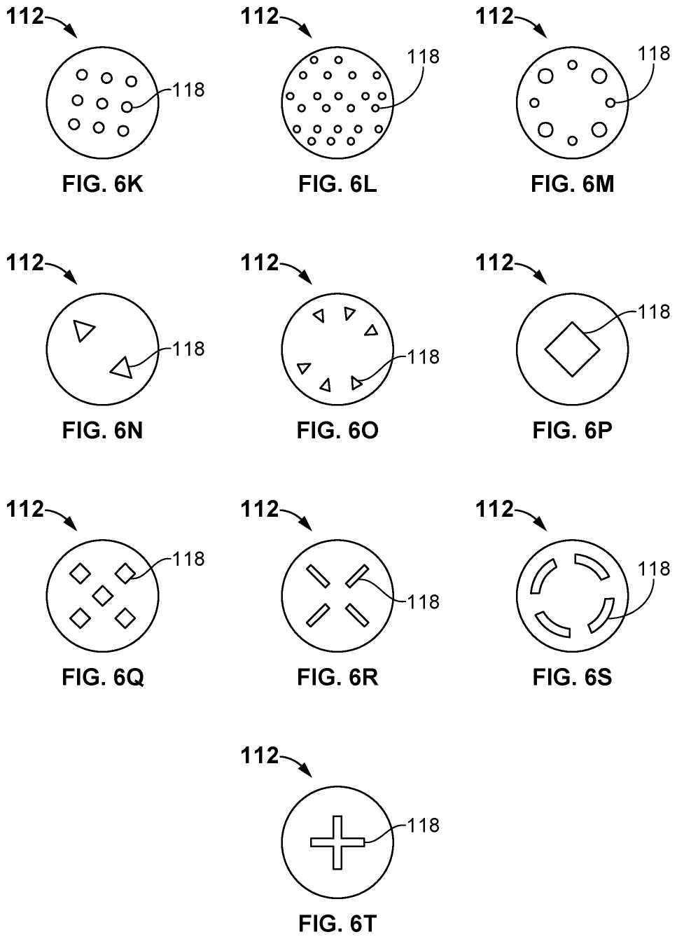

Referring to FIG. 3A-FIG. 3H through FIG. 5A-FIG. 5J, various shapes and sizes of the membrane 112 are experimented to determine an appropriate shape size that improves the performance of the membrane 112, according to one embodiment of the present invention. The membranes 112 are shaped to cover the majority of the cross-section of the compartment with one or more perforations 118 (shown in FIG. 6A-FIG. 6T) for liquid passage and even distribution of liquid. In one embodiment, the membrane 112 has symmetric and evenly distributed holes or perforations 118. The perforations 118 may not directly align with the point(s) of entry of the pressurized liquid into the compartment. As a result, the membrane 112 having symmetric and evenly distributed perforations 118 provides improved performance. The membrane 112 having symmetric and evenly distributed perforations 118 allows successful passage of the liquid and optimal distribution of the liquid among all the hygroscopic substances inside the compartment, resulting in better extraction of essences of the hygroscopic substance(s).

In one embodiment, various thicknesses and masses of the membrane 112 are experimented to determine an appropriate thickness and mass which improves the performance of the membrane 112. Membrane 112 with adequate mass and thickness resists the pressure of the flow of liquid. The membrane 112 does not crumble or fold and exhibits improved performance. Membrane 112 assists the liquid passage as well as an even and optimal extraction of the essence of the hygroscopic substance(s) into the liquid.

In one embodiment, various materials of membrane 112 are experimented to determine an appropriate material that improves the performance of the membrane 112. The materials include, but not limited to, plastic, glass, organic fibers, paper, and metals.

In one embodiment, various textured patterns of the membrane 112 are experimented to determine an appropriate pattern which improves the performance of the membrane 112. The membrane 112 may include a textured surface having various types of textured patterns. The textured patterns include, but are not limited to, one or more perforations 118 or ridges 114. The textured patterns may have various sizes, shapes, numbers and layouts. In one embodiment, the membrane 112 is a mesh type membrane. The membrane 112 with adequate number and size of perforations 118 allows successful and steady passage of liquid through the compartment, which offers some resistance against the pressure. The membrane 112 with symmetric and evenly distributed perforations 118 exhibits improved performance for extraction of the essence from the hygroscopic substance(s).

FIG. 6A-6T exemplarily illustrates a top view of the membrane having different patterns of perforations 118, according to an embodiment of the present invention. In one embodiment, the membrane 112 may not include any perforations 118 as shown in FIG. 6A. FIG. 6B-FIG. 6M exemplarily illustrates the membrane 112 with one or more perforations 118. The perforations 118 may be circular in shape. In one embodiment, the membrane 112 includes at least one hole 118 as shown in FIG. 6B-FIG. 6C. The hole 118 may have different dimensions. In one embodiment, the membrane 112 includes at least one hole 118 proximal to the edge of the membrane 112 as shown in FIG. 6D. In one embodiment, the membrane 112 includes two or more perforations 118 with different dimensions as shown in FIG. 6E-FIG. 6I. The perforations 118 may be located proximal to the edge of the membrane 112. In one embodiment, the membrane 112 includes a plurality of perforations 118 with different dimensions as shown in FIG. 6J-FIG. 6L. In one embodiment, the membrane 112 includes a plurality of alternatively arranged perforations 118 of different dimensions as shown in FIG. 6M.

In one embodiment, the membrane 112 has one or more perforations 118 in the shape of a triangle. In FIG. 6N, the triangular perforations 118 face outwards. In FIG. 6O, the triangular perforations 118 face inwards, that is, towards the center of the membrane 112. In one embodiment, the membrane 112 has one or more perforations 118 in the shape of a square as shown in FIG. 6P-FIG. 6Q. In one embodiment, the membrane 112 has one or more perforations 118 in the shape of a rectangle as shown in FIG. 6R. In one embodiment, the membrane 112 has one or more perforations 118 in different polygonal shapes as shown in FIG. 6S-FIG. 6T.

Advantageously, the beverage capsule 100 enables the use of hygroscopic substances such as leaves, granules, or water-soluble derivatives, inside sealed single-serve capsules that could be used in the beverage production device for extraction of beverage using pressurized liquid. The capsule 100 enables the use of actual tea leaves to produce authentic tea beverage, instead of alternative tea derivatives such as instant powders or steeped granules. Further, the capsule 100 enables the use of fully sealed capsule body 102 that better conserves hygroscopic substance(s) and protects from external elements such as oxygen, light, and humidity, which provides longevity, potency, and quality improvement. The capsule 100 further modifies flow rate and flow distribution of the liquid so as to offer resistance to the flow of the liquid and distributes the liquid more evenly across the hygroscopic substance(s) to enable optimal extraction of essence from the hygroscopic substance(s) as the liquid exits through the capsule 100 as beverage.

One aspect of the present disclosure is directed to a beverage capsule. The capsule comprises a capsule body that includes a base, an injection wall and a plurality of sidewalls extending between the base and injection wall to form a hermetically sealed compartment. The base comprises one or more openings and a lid detachably affixed to the base to close the openings, and the compartment comprises at least a layer of hygroscopic substance. The injection wall is used as a liquid entry surface and is configured to be pierced to allow flow of liquid from a beverage preparation device to flow through the hygroscopic substance. The entry surface or base may be configured to enable the dispensing of the liquid flowing through the hygroscopic substance. The capsule may further comprise one or more objects disposed within the compartment. The object may be configured to modify the flow rate and flow distribution of the liquid so as to offer resistance to the flow of the liquid and distributes the liquid evenly across the hygroscopic substance to enable optimal extraction of essence from the hygroscopic substance as the liquid exits through the base.

In one example, the object(s) may comprise one or more perforations, and may be disposed at least one above and one below the hygroscopic substance. Moreover, in another example, the object(s) may be mixed with the hygroscopic substance(s) or disposed between two or more layers of the hygroscopic substance(s). The object(s) comprise, in one example, at least one textured surface and a smooth surface and have one or more channels defined at an exterior surface of the object. In one example, the object(s) comprises one or more ridges defined at the exterior surface of the object. The plurality of objects may comprise different characteristics including shape, dimension, arrangement of perforations, arrangement of ridges and arrangement of perforations.

In one example, the object(s) are one or more membranes disposed within the compartment and transverse to the flow of liquid. In a related embodiment, the compartment has a c-shaped cross-section, and the membrane has a c-shaped profile complementary to the cross-section of the compartment to enable the membrane to snugly fit within the compartment. The membrane may comprise one or more perforations. In a related embodiment, the perforations may be evenly distributed across a surface of the membrane. The perforations may be, in one example, symmetrically distributed across a surface of the membrane. The membrane may comprise at least one of a textured surface and a smooth surface. The membrane may comprise one or more legs extending from the surface of the membrane towards the substance in the compartment. The membrane may be disposed at least one above and one below the substance. In one example, the membranes are disposed between two or more layers of the substance.

One aspect of the present disclosure is directed to a method of extracting the essence from a hygroscopic substance, comprising placing a capsule into a beverage dispensing device, introducing liquid into the capsule, and extracting the essence from the hygroscopic substance as the liquid exits the capsule. The capsule used for the disclosed method comprises a penetrating surface, an exit surface and a plurality of sidewalls that extend between the penetrating surface and the exit surface to form a sealed compartment. The exit surface may comprise one or more openings and a lid detachably affixed to the exit surface to close the openings. The compartment includes at least a layer of hygroscopic substance, and the entry surface may be configured to be pierced to allow flow of liquid from a beverage dispensing device to flow through the hygroscopic substance. The exit surface is configured to dispense the liquid flowing through the hygroscopic substance. The one or more objects may be disposed within the compartment, and the object is configured to modify the flow rate and flow distribution of the liquid so as to offer resistance to the flow of the liquid and distribute the liquid evenly across the hygroscopic substance.

The foregoing description comprises illustrative embodiments of the present disclosure. Having thus described exemplary embodiments of the present disclosure, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method.

Many modifications and other embodiments of the disclosure will come to mind to one skilled in the art to which this disclosure pertains having the benefit of the teachings presented in the foregoing descriptions. Although specific terms may be employed herein, they are used only in generic and descriptive sense and not for purposes of limitation. Accordingly, the present disclosure is not limited to the specific embodiments illustrated herein. While the above is a complete description of the preferred embodiments of the disclosure, various alternatives, modifications, and equivalents may be used. Therefore, the above description and the examples should not be taken as limiting the scope of the disclosure, which is defined by the appended claims.

1. An enclosed capsule, comprising:
a) a capsule body, constructed of non-porous material(s), wherein one or more surface areas of the capsule body are configured to allow piercing to enable entry of a liquid, and one or more surface areas of the capsule body are configured to allow for piercing to enable exit of a liquid; and
b) one or more substances comprising at least one hygroscopic substance, disposed within the capsule body prior to the capsule being sealed; and
c) one or more objects disposed within the capsule body prior to the capsule being sealed, wherein the object(s) are configured to modify the flow characteristics of a pressurized liquid through the capsule body.

2. The capsule of claim 1, wherein at least one object comprises one or more perforations.

3. The capsule of claim 1, wherein at least one object comprises one or more internal open channels.

4. The capsule of claim 1, wherein at least one object is a solid structure with no holes.

5. The capsule of claim 1, wherein at least one object is disposed a) between substance(s) and one or more cavity boundaries, or b) between layers of substance(s), or c) in a mix with the substance(s).

6. The capsule of claim 1, wherein at least one object comprises at least one textured surface, smooth surface, recession on a surface, channel on a surface, or ridge on a surface.

7. The capsule of claim 1, wherein at least one object is attached to one or more cavity surfaces.

8. The capsule of claim 1, wherein at least one object is detached from cavity surfaces.

9. The capsule of claim 1, wherein at least one object fits snugly inside a cavity such that it may not relocate.

10. The capsule of claim 1, wherein at least one object may relocate within a cavity.

11. The capsule of claim 1, wherein at least one object comprises at least one curved surface, or at least one object comprises at least one planar surface, or at least one object resembles a surface due to its dimensions, or at least one object is spherical in geometry, or at least one object is polytopal in geometry, or at least one object comprises at least one convex surface, or at least one object comprises at least one concave surface.

12. A beverage capsule, comprising:
a) a capsule body that includes a base, an injection wall and a plurality of sidewalls extending between the base and injection wall to form a hermetically sealed compartment,
wherein the base comprises one or more openings and a lid detachably affixed to the base to close the openings,
wherein the compartment comprises at least a layer of hygroscopic substance,
wherein the injection wall is configured to be pierced to allow flow of liquid from a beverage preparation device to flow through the hygroscopic substance, and
wherein the base is configured to dispense the liquid flowing through the hygroscopic substance, and
b) one or more objects disposed within the compartment,
wherein the object is configured to modify the flow rate and flow distribution of the liquid so as to offer resistance to the flow of the liquid and distributes the liquid evenly across the hygroscopic substance to enable optimal extraction of essence from the hygroscopic substance as the liquid exits through the base.

13. The beverage capsule of claim 12, wherein the objects comprise one or more perforations.

14. The beverage capsule of claim 12, wherein the objects are disposed at least one of above and below the hygroscopic substance.

15. The beverage capsule of claim 12, wherein the objects are disposed between two or more layers of the hygroscopic substance.

16. The beverage capsule of claim 12, wherein the objects are mixed with the hygroscopic substance.

17. The beverage capsule of claim 12, wherein the objects comprise at least one of a textured surface and a smooth surface.

18. The beverage capsule of claim 12, wherein the object comprises one or more ridges defined at the exterior surface of the object.

19. The beverage capsule of claim 12, wherein the plurality of objects comprises different characteristics including shape, dimension, arrangement of perforations, arrangement of ridges and arrangement of perforations.

20. The beverage capsule of claim 12, wherein the objects are one or more membranes disposed within the compartment and transverse to the flow of liquid.

21. The beverage capsule of claim 20, wherein the compartment has a c-shaped cross-section and the membrane has a c-shaped profile complementary to the cross-section of the compartment to enable the membrane to snugly fit within the compartment.

22. The beverage capsule of claim 20, wherein the membrane comprises one or more perforations and further comprises at least one of a textured surface and a smooth surface.

23. The beverage capsule of claim 20, wherein the membrane comprises one or more legs extending from the surface of the membrane towards the substance in the compartment.

24. The beverage capsule of claim 20, wherein the membranes are disposed between two or more layers of the substance.

25. A method of extracting the essence from a hygroscopic substance, comprising:
a) placing a capsule into a beverage dispensing device,
wherein the capsule comprises a penetrating surface, an exit surface and a plurality of sidewalls that extend between the penetrating surface and the exit surface to form a sealed compartment,
wherein the exit surface comprises one or more openings and a lid detachably affixed to the exit surface to close the openings,
wherein the compartment comprises at least a layer of hygroscopic substance,
wherein the entry surface is configured to be pierced to allow flow of liquid from a beverage dispensing device to flow through the hygroscopic substance,
wherein the exit surface is configured to dispense the liquid flowing through the hygroscopic substance,
wherein one or more objects are disposed within the compartment, and the object is configured to modify the flow rate and flow distribution of the liquid so as to offer resistance to the flow of the liquid and distribute the liquid evenly across the hygroscopic substance;
b) introducing liquid into the capsule; and
c) extracting the essence from the hygroscopic substance as the liquid exits through the exit surface.
